(19) United States
(12) Patent Application Publication
(10) Pub. No.: US 2008/0214353 A1
(43) Pub. Date: Sep. 4, 2008

(54) Hydraulic system for controlling a belt-driven conical-pulley transmission

(75) Inventors: Roshan Willeke, Karlsruhe (DE); Eric Muller, Kaiserslautern (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 12/072,134

(22) Filed: Feb. 21, 2008

Related U.S. Application Data
(60) Provisional application No. 60/902,561, filed on Feb. 21, 2007.
(60) Provisional application No. 60/902,562, filed on Feb. 21, 2007.
(60) Provisional application No. 60/902,563, filed on Feb. 21, 2007.
(60) Provisional application No. 60/919,398, filed on Mar. 22, 2007.
(60) Provisional application No. 60/937,273, filed on Jun. 26, 2007.
(60) Provisional application No. 60/937,274, filed on Jun. 26, 2007.
(60) Provisional application No. 60/937,275, filed on Jun. 26, 2007.
(60) Provisional application No. 60/937,276, filed on Jun. 26, 2007.

(51) Int. Cl. F16H 61/00; F16H 63/00; B62K 11/00

(52) U.S. Cl. 477/45; 474/18; 180/219

(57) ABSTRACT

A hydraulic system for controlling a belt-driven conical-pulley transmission of a motor vehicle, wherein the transmission has a variably adjustable transmission ratio. The hydraulic system includes a first valve arrangement to control a contact pressure in the belt-driven conical-pulley transmission, a second valve arrangement to control the transmission ratio of the belt-driven conical-pulley transmission, and a hydraulic energy source to supply the hydraulic system with hydraulic energy. In order to provide an improved hydraulic system, the system includes a third valve arrangement for controlling a forward clutch and a reverse clutch, and for controlling a parking lock.

### BACKGROUND OF THE INVENTION

1. Field of the Invention

The present invention relates to a hydraulic system for controlling a belt-driven conical-pulley transmission (CVT) of a motor vehicle having a variably adjustable transmission ratio. The hydraulic system includes a first valve unit to ensure a contact pressure of the belt-driven conical-pulley transmission, a second valve unit to control the transmission ratio of the belt-driven conical-pulley transmission, and a hydraulic energy source to supply the hydraulic system with hydraulic energy. The present invention also relates to a belt-driven conical-pulley transmission controlled thereby and to a motor vehicle equipped therewith.

2. Description of the Related Art

Belt-driven conical-pulley transmissions can have a continuously variable transmission ratio, in particular automatically effected transmission ratio variation.

Such continuously variable automatic transmissions include, for example, a startup unit, a reversing planetary gearbox as the forward/reverse drive unit, a hydraulic pump, a variable speed drive unit, an intermediate shaft, and a differential. The variable speed drive unit includes two pairs of conical disks and an encircling member. Each conical disk pair includes one conical disk that is movable in an axial direction. Between the pairs of conical disks runs the encircling element, for example a steel thrust belt, a tension chain, or a drive belt. Axially moving the movable conical disk changes the running radius of the encircling member, and thus the transmission ratio of the continuously variable automatic transmission.

Continuously variable automatic transmissions require a high level of contact pressure applied to the encircling member in order to be able to move the axially movable conical disks of the variable speed drive unit with the desired speed at all operating points, and also to transmit the torque with sufficient basic pressure with minimum wear.

An object of the present invention is to provide a hydraulic system for a belt-driven conical-pulley transmission and/or a belt-driven conical-pulley transmission that has a hydraulic shift-by-wire control and that can replace mechanical actuation of the parking lock and the clutch selection.

### SUMMARY OF THE INVENTION

The above-identified object is achieved with a hydraulic system in accordance with the present invention for controlling a belt-driven conical-pulley transmission of a motor vehicle having a variably adjustable transmission. The hydraulic system includes a first valve arrangement to ensure a desired belt contact pressure in the belt-driven conical-pulley transmission, a second valve arrangement to control the transmission ratio of the belt-driven conical-pulley transmission, a hydraulic energy source to supply the hydraulic system with hydraulic energy, and a third valve arrangement to control a forward and a reverse clutch, and also to control a parking lock. The forward clutch, the reverse clutch, and the parking lock are parts of a power train of the motor vehicle, and can optionally be actuated by means of the third valve arrangement, wherein the motor vehicle moves forward when the forward clutch is actuated and the motor vehicle moves backward when the reverse clutch is actuated, and rolling away can be prevented when the parking lock is engaged. A mechanical intervention by means of a gearshift lever operable by a driver of the motor vehicle, for example, is not necessary to engage the forward or reverse gear and/or the parking lock of the motor vehicle.

A preferred exemplary embodiment of the hydraulic system is characterized in that the third valve arrangement includes a first valve having a first control piston for mechanical actuation of the parking lock and for hydraulic actuation of the forward and reverse clutches. Advantageously, both the hydraulic actuation of the clutches and the mechanical actuation of the parking lock can be effected by means of a single first control piston of the first valve. Additional hydraulic sliders are not needed.

Another preferred exemplary embodiment of the hydraulic system is characterized in that the third valve arrangement includes a second valve positioned upstream from the first valve to supply the first valve with a system pressure or optionally with a pilot pressure or control pressure for the hydraulic system. Advantageously, the pilot pressure can be used to actuate the clutches hydraulically. To release the parking lock, in particular in the event that greater forces are necessary, the comparatively higher system pressure can be applied by means of the second valve.

Another preferred exemplary embodiment of the hydraulic system is characterized in that the third valve arrangement includes a third valve positioned upstream from the first valve to actuate the first control piston of the first valve. The third valve can be designed as a control valve, especially as an electrically actuatable proportional valve. Advantageously, the first valve can be switched by means of the second valve to a corresponding control surface of the first control piston of the first valve, to actuate the clutches.

Another preferred exemplary embodiment of the hydraulic system is characterized in that the third valve arrangement includes a fourth valve positioned upstream from the second valve to actuate a second control piston of the second valve. By means of the second control piston, the second valve can connect the first valve optionally to the system pressure or to the pilot pressure.

Another preferred exemplary embodiment of the hydraulic system is characterized in that the first control piston of the first valve is connected to actuate the parking lock mechanically through a lever of a selector shaft of the belt-driven conical-pulley transmission. Through the mechanical connection, a corresponding cog of the parking lock can be made to mesh appropriately with a component of the power train to block the power train of the motor vehicle.

Another preferred exemplary embodiment of the hydraulic system is characterized in that the lever and/or the selector shaft is connected to an engagement spring to provide an engagement force to engage the parking lock. In the unpressurized state the parking lock can thus be applied automatically by means of the spring.

Other preferred exemplary embodiments of the hydraulic system are characterized in that by means of the first control piston of the first valve the following are optionally alternatively actuatable:
a first selector position (P) to engage the parking lock and to switch the forward and reverse clutches to zero pressure,
a second selector position (R) to apply pressure to the reverse clutch and to switch the forward clutch to zero pressure,
a third selector position (N) to switch the forward and reverse clutches to zero pressure, and
a fourth selector position (D) to apply pressure to the forward clutch and to switch the reverse clutch to zero pressure.

The forward and reverse clutches can be clutches that are disengaged when unpressurized. However, it is also conceivable to design the reverse and forward clutches so that they are engaged when unpressurized. Accordingly, in the first and third selector positions the control piston could be switched so that both clutches are under pressure. When the forward and reverse clutches are designed as clutches that are disengaged when unpressurized it results in a safety benefit, since in the event of a possible occurrence of a pressure loss of the hydraulic energy source the neutral position results without further action, i.e., unpressurized forward and reverse clutches, whereby the vehicle can continue to move in free wheeling, or the parking lock is engaged for safety as soon as the vehicle has come to a stop.

Another preferred exemplary embodiment of the hydraulic system is characterized in that the first valve is actuatable with the system pressure to change from the first selector position (P) to the second selector position (R). The parking lock can be securely actuated by means of the comparatively high system pressure.

Another preferred exemplary embodiment of the hydraulic system is characterized in that the first valve is actuatable with the pilot pressure to actuate the second through fourth selector positions (R, N, D). The pilot pressure can be provided by means of the third valve to move to those selector positions.

Another preferred exemplary embodiment of the hydraulic system is characterized in that a detector is provided to detect the first through fourth selector positions (P, R, N, D) of the first control piston. Advantageously, by means of the detector the actual shift conditions of the first control piston can be recognized and forwarded for further processing. The data thus obtained can be used for a display of the selector position actually chosen, for example. From the aspect of safety, it is possible to use the data so obtained to recognize possibly unwanted intermediate states or an unwanted selector position. For example, if an unwanted selector position results, that can be utilized to initiate an emergency function, for example emergency shutoff.

Another preferred exemplary embodiment of the hydraulic system is characterized in that the first valve is connected downstream of the hydraulic energy source through a fifth valve. The supply of hydraulic energy to the first valve can be controlled by means of the fifth valve.

Another preferred exemplary embodiment of the hydraulic system is characterized in that the fifth valve is connected downstream to a sixth valve to actuate the fifth valve. The fifth valve can be actuated by means of the sixth valve, which can be designed as a control valve, for example as an electrically actuatable proportional valve. It is conceivable to design the fifth valve so that by a corresponding control of the sixth valve it completely separates the first valve from the hydraulic energy source, and at the same time switches the first valve to the tank. That can be used advantageously as an emergency shutoff, wherein the reverse clutch and the forward clutch can be switched to zero pressure and therefore disengage, with the belt-driven conical-pulley transmission being shifted automatically to the neutral position. As an additional safety provision, it is conceivable to design the first control piston of the first valve so that in the unpressurized state, i.e., without control pressure from the third valve, it moves automatically into a selector position in which the forward and reverse clutches are switched to zero pressure.

Another preferred exemplary embodiment of the hydraulic system is characterized in that a fourth valve arrangement is provided to control a volumetric flow of cooling oil, in particular for cooling the clutches. Components of the power train, for example the forward and reverse clutches, a centrifugal oil cover, and/or the conical disks, as well as the encircling element of the belt-driven conical-pulley transmission, can advantageously be subjected to a controlled volumetric flow of cooling oil by means of the fourth valve arrangement.

Another preferred exemplary embodiment of the hydraulic system is characterized in that the fourth valve arrangement includes the fourth valve for actuation. The fourth valve can thus simultaneously actuate the second valve and the fourth valve arrangement.

The object is also achieved with a belt-driven conical-pulley transmission having a hydraulic system as described above.

The object is also achieved with a motor vehicle having a belt-driven conical-pulley transmission as described above.

### BRIEF DESCRIPTION OF THE DRAWINGS

The structure, operation, and advantages of the present invention will become further apparent upon consideration of the following description taken in conjunction with the accompanying drawings, in which:

FIG. 1 is a hydraulic circuit diagram of an embodiment of a hydraulic system in accordance with the present invention for controlling a belt-driven conical-pulley transmission;

FIG. 2 is a schematic view of a first control piston of a first valve for actuating a forward and a reverse gear and a parking lock, together with a mechanism of the parking lock; and

FIG. 3 is a graph showing the pilot pressure or system pressure switched at the first valve by means of the second valve, as a function of the selector positions of the first control piston of the first valve.

### DESCRIPTION OF THE PREFERRED EMBODIMENTS

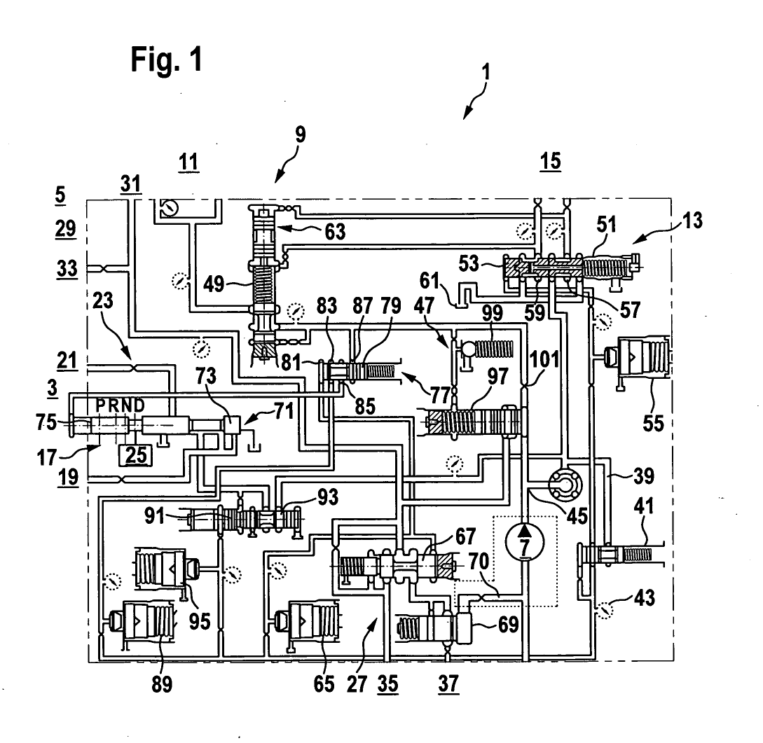

FIG. 1 shows a portion of a circuit diagram of a hydraulic system 1 in accordance with an embodiment of the present invention. Hydraulic system 1 is used to control a belt-driven conical-pulley transmission, which is indicated generally by reference numeral 3 in FIG. 1. Belt-driven conical-pulley transmission 3 can be part of a power train of a motor vehicle, which is indicated by reference numeral 5. Hydraulic system 1 includes a hydraulic energy source 7, for example a mechanically or electrically driven hydraulic pump to deliver a hydraulic medium. For a drive source, the hydraulic energy source 7 can be connected to an internal combustion engine (not shown) of the motor vehicle 5. Hydraulic energy source 7 serves to supply hydraulic system 1 with hydraulic energy.

Connected downstream from hydraulic energy source 7 is a first valve arrangement 9, which is connected to a torque sensor, indicated generally by reference numeral 11. First valve arrangement 1 and torque sensor 11 serve to provide and/or control a contact pressure to transfer torque between conical disks and a corresponding encircling element of belt-driven conical-pulley transmission 3, particularly as a function of the torque present at belt-driven conical-pulley transmission 3. Downstream, torque sensor 11 is connected through a cooler (not shown) to a cooler return 31. Torque sensor 11 can raise or lower a system pressure 45 delivered by the hydraulic energy source, as a function of the torque that is present.

A second valve arrangement 13 is also connected downstream from hydraulic energy source 7. Second valve arrangement 13 is connected to conical disks indicated generally by reference numeral 15, and serves to adjust the positions of the conical disks, i.e., to set the transmission ratio of belt-driven conical-pulley transmission 3.

Also connected downstream from hydraulic energy source 7 is a third valve arrangement 17, which is connected to actuate a forward clutch, indicated generally by reference numeral 19 and a reverse clutch, indicated generally by reference numeral 21.

A hydraulic parking-lock release system 23 is also connected downstream from hydraulic energy source 7. The parking-lock release system 23 of hydraulic system 1 is connected to a mechanical parking lock, indicated generally by reference numeral 25. The connection can be effected by means of suitable mechanical aids, for example a lever. By means of the parking-lock release system 23, the mechanical parking lock 25 of motor vehicle 5 can be engaged, i.e., established, and released again.

Hydraulic energy source 7 also serves to supply a fourth valve arrangement 27. Fourth valve arrangement 27 serves to provide a volumetric flow of cooling oil that is likewise provided by means of hydraulic energy source 7. To that end, fourth valve arrangement 27 is connected to a cooling circuit, indicated generally by reference numeral 29, particularly to the cooler return 31, to an active Hytronic cooling system, indicated generally by reference numeral 33, to a jet pump, indicated generally by reference numeral 35, and to a centrifugal oil cover, indicated generally by reference numeral 37.

Hydraulic energy source 7 is connected downstream through a branch 39 to a pilot-pressure-regulating valve 41. Pilot pressure regulating valve 41 regulates a downstream pilot pressure 43, of around 5 bar, for example, while the hydraulic energy source 7 provides a higher system pressure 45. The pilot pressure serves in a known way by means of suitable proportional valves, for example electrically actuatable proportional valves, to control the circuit components of hydraulic system 1.

To set a maximum volumetric oil flow to torque sensor 11 and to limit excess oil conveyed to the cooler return 31, a fifth valve arrangement 47 is provided.

To set or regulate the system pressure 45 ahead of torque sensor 11, the latter includes pressure regulating valves (not shown). First valve arrangement 9 includes a system pressure valve 49 connected upstream of torque sensor 11. System pressure valve 49 is connected downstream from fifth valve arrangement 47, and allows an appropriate volumetric flow for torque sensor 11 to pass, while the system pressure 45 upstream can be adjusted to a minimum system pressure, for example 6 bar. To set an adjusting pressure through short-term additional elevation of the system pressure 45, system pressure valve 49 is additionally connected upstream to second valve arrangement 13 through an OR element 63.

Second valve arrangement 13 includes a seventh valve 51 that has a seventh control piston 53 and is connected downstream from hydraulic energy source 7. Seventh control piston 53 is connected downstream to an eighth valve 55 for actuation. The eighth valve 55 can be a control valve, for example an electrically actuatable proportional valve. Seventh valve 51 has a first port 57 and a second port 59, which are each connected to corresponding adjusting elements of the conical disks 15. By means of the seventh control piston 53 of the seventh valve 51, hydraulic energy source 7 can optionally be connected continuously, i.e., with transfer flow, to first port 57 or to second port 59. The particular port that is not connected to the hydraulic energy source 7 can accordingly be connected to a tank 61. In a middle position of control piston 53 both ports 57 and 59 can be disconnected from the hydraulic energy source 7 and switched to the tank 61. Thus, a desired pressure ratio can be set in ports 57 and 59 by means of the seventh valve 51 of second valve arrangement 13 to adjust the conical disks 15. In addition, ports 57 and 59 are connected to system pressure valve 49 through the OR element 63. Through that connection the minimum system pressure adjusted by means of system pressure valve 49 can be adapted by a desired amount to the seventh valve 51, i.e., raised by means of adjusting motions made by valve 49, for example.

Fourth valve arrangement 27 includes a cooling oil regulating valve 67 that is controlled by means of a fourth valve 65. Cooling oil regulating valve 67 is connected downstream from the fifth valve system 47, and is supplied thereby with hydraulic energy particularly by means of hydraulic energy source 7. In addition, fourth valve arrangement 27 has a return valve 69, which is connected upstream directly to hydraulic energy source 7 or to a pump injector 70 of hydraulic energy source 7. Return valve 69 is connected downstream with a direct connection to centrifugal oil cover 37 through a port of return valve 69, and as the volumetric flows rise it conveys a partial flow directly into the pump injector 70. Cooling oil regulating valve 67 serves to regulate and maintain a desired volumetric flow of cooling oil to the components that are to be cooled.

The third valve arrangement 17 includes a first valve 71 with a first control piston 73. To actuate the first control piston 73 it is connected to a downstream third valve 75, a control valve such as an electrically actuatable proportional valve, for example. The first control piston 73 of the first valve 71 can assume essentially four selector positions to actuate the forward clutch 19, the reverse clutch 2, and the parking lock 25.

In a first selector position of the first control piston 73 of the first valve 71, labeled P in FIG. 1, first control piston 73 is all the way to the left, corresponding to an engaged parking lock 25.

In a second selector position, labeled R in FIG. 1, the reverse clutch 21 can be subjected to a clutch actuating pressure. The clutch actuating pressure can be produced by lowering the system pressure 45 by means of valve 91.

In a third selector position, labeled N in FIG. 1, the forward and reverse clutches 19, 21 can be connected to the tank by means of the first control piston 73.

In a fourth selector position, shown in FIG. 1 and labeled D, the forward clutch 19 can be subjected to the clutch actuating pressure. To actuate an end surface 75 of first control piston 73, the end surface is connected downstream to a second valve 77 having a second control piston 79.

Second valve 77 has a total of four control flow inlets. A first control flow inlet 81 is connected downstream to the fourth valve 65 to actuate the second control piston 79. A second control flow inlet 83 is connected downstream to a third valve 89. A third control flow inlet 85 is connected upstream to end surface 75 of first control piston 73. A fourth control flow inlet 87 of second valve 77 is connected downstream to the hydraulic energy source 7.

In a first selector position, second control piston 79 joins the second control flow inlet 83 to the third control flow inlet 85, so that first control piston 73 is actuatable by means of third valve 89, which can be designed as an electrically actuatable proportional valve. In a second selector condition, which corresponds to a movement of second control piston 79 to the right, the third control flow inlet 85 and the fourth control flow inlet 87 are connected to each other, so that the end surface 75 of first control piston 73 can be subjected to the system pressure supplied by hydraulic energy source 7. That switching position of second valve 77 can be actuated in order to release the parking lock 25, i.e., to move first control piston 73 from its selector position P into switch position R. The pilot pressure to move second control piston 79 is supplied by fourth valve 65, which simultaneously also serves to actuate cooling oil regulating valve 67.

It is possible to operate fourth valve 65 in various ranges, for example in a first range between 0 and 200 mA merely for pilot control of second valve 77; in a second range, for example between 200 and 500 mA, for pilot control of second valve 77 and simultaneously to activate the cooling system, where the control piston of the cooling oil regulating valve 67 responds; and in a third range, for example between 500 and 800 mA, in which the second piston 79 of the second valve 77 applies the system pressure 45 to the first valve 71 without throttling, and the cooling oil regulating valve sets maximum cooling.

Hydraulic system 1 includes a fifth valve 91 connected downstream from hydraulic energy source 7 to supply the clutches 19 and 21 with the clutch actuating pressure. A fifth control piston 93 of the fifth valve 91 can be adjusted so that the downstream first valve 71 can optionally be connected without pressure, i.e., to the tank 61, or subjected to a conventionally reduced system pressure 45. To actuate the fifth control piston 93, a corresponding control surface is connected downstream from a sixth valve 95. The sixth valve 95 can likewise be designed as an electrically actuatable proportional valve.

For priority supply of the moment sensor 11 with hydraulic energy supplied by means of the hydraulic energy source 7, hydraulic system 1 includes a ninth valve 97 that uses a pressure relief valve 99 to adjust the pressure ratios so that overpressures cannot develop at high volumetric flows, whereby an excessive volumetric flow is introduced particularly into the cooling oil circuit 29. Up to a minimum flow volume determined by means of an orifice 101, second valve arrangement 13, the pilot pressure regulating valve 41 and the fifth valve 91, system pressure valve 49, and the downstream torque sensor 11 are supplied with hydraulic energy on a priority basis.

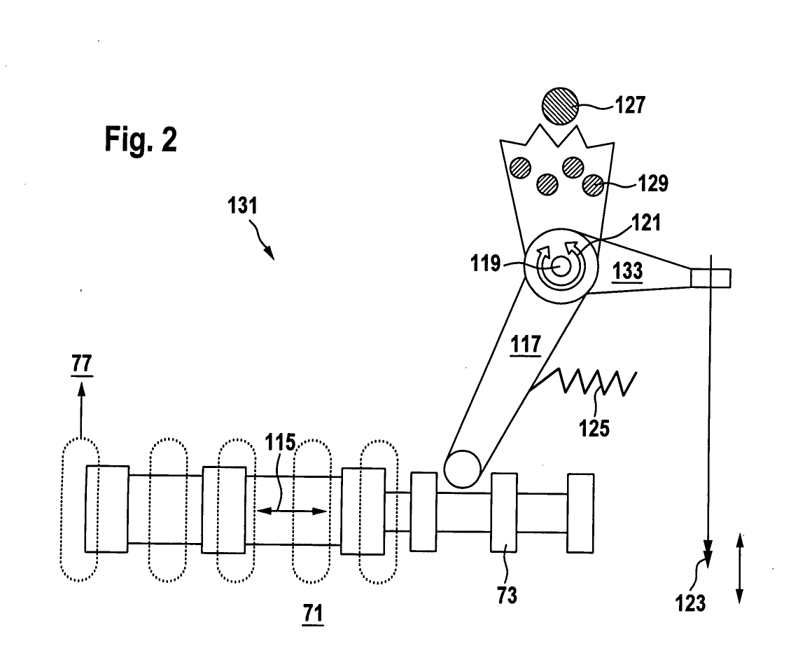

FIG. 2 shows a schematic view of a parking-lock release system 131, with the first piston 73 of the first valve 71 being indicated schematically. It is evident that a lever 117 of a mechanism of the parking-lock release system 131 is mechanically engaged with the first control piston 73. A movement of the first control piston 73 to the right or left actuated by means of the second valve 77, indicated by a double-headed arrow 115 and as viewed in the orientation of FIG. 2, causes a rotary motion of a selector shaft 119, indicated by a curved double-headed arrow 121. To release a parking pawl 123, the first control piston 73 can be moved to the right, as viewed in the orientation of FIG. 2, while selector shaft 119 can be rotated counter-clockwise, whereupon parking pawl 123 is actuatable by means of another lever 133. The energy needed for that operation, which can be comparatively high, for example in the case of a vehicle 5 parked on a slope, can be delivered by actuating the second valve 77 with the system pressure 45.

To detect the position of lever 133, a position sensor 127 can be provided, which interacts by means of magnets 129, for example, that are associated with the selector shaft 119. The selector position of the parking pawl 123 can be determined by means of the position sensor 127 and the magnets 129. An engaging spring 125 acts against lever 117 to provide an opposing spring force to oppose clockwise movement of selector shaft 119 and associated levers 117 and 133.

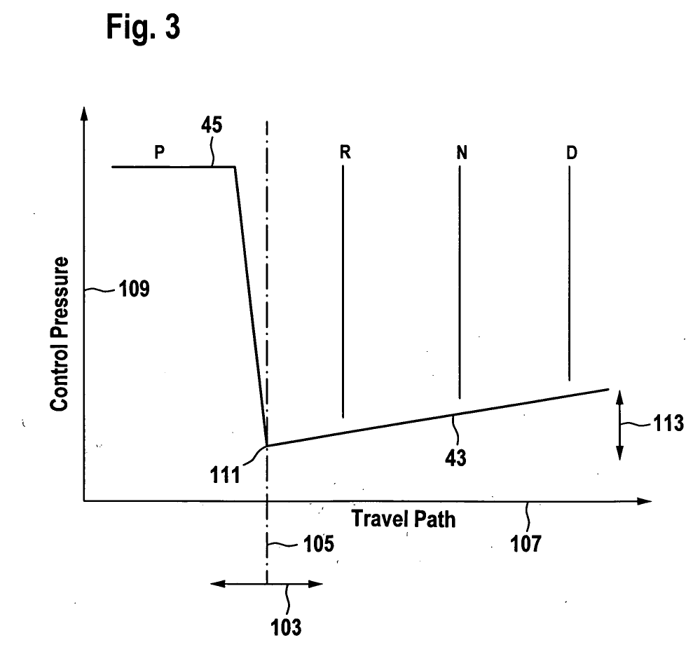

FIG. 3 shows a graph of the control pressure acting on the first control piston 73 of the first valve 71, as a function of the various selector positions P, R, N, and D. The direction of motion of first control piston 73 is indicated by a double-headed arrow 103. A dash-dotted line 105 indicates a shift process of second control piston 79 of second valve 77, where the control pressure acting on first control piston 73 is switched over from the system pressure 45 to the control pressure 43 set by the valve 89. The travel path of first control piston 73 is plotted on the X-axis 107. The control pressure acting on the end surface 75 of the first control piston 73 is plotted on the Y-axis 109. It is evident that switching the second valve 77 causes the control pressure to drop off steeply to a discontinuous turning point 111 that coincides with the dash-dotted line 105. After that turning point the third valve 89 takes over the actuation of first control piston 73, with control piston 73 moving first to selector position R, then to selector position N, then to selector position D, as the pressure increases. The rise and fall of the control pressure set by the third valve 89 is indicated by a double-headed arrow 113. To release the parking lock 25, the comparatively high system pressure 45 can be applied, which is shown to the lift side of the dash-dotted line of FIG. 3.

Advantageously, hydraulic system 1 enables hydraulic actuation and selection of the forward and reverse clutches 19, 21, of the cooling of the clutches 19, 21, of the adjustment of the disk sets of the belt-driven conical-pulley transmission 3 and of the corresponding bias of the disk sets, of the provision of a volumetric oil flow through a cooler (not shown) by way of the cooling oil circuit 29, and of the actuation of the parking lock 25 integrated into an actuator or the first control piston 73 of the first valve 71 for selecting the clutches 19, 21.

Acting against the end surface 75 of the first control piston 73 are selectively the system pressure 45 when shifting from P to R, and a control pressure set by valve 89 when shifting from R to N to D. That is necessary since a high force (see FIG. 3) must be applied from P to R (release parking lock) in order to pull the parking lock 25 out of its notch via the selector shaft 119 (see FIG. 2). The second valve 77 distributes the two different working pressures to the first valve 71. The transfer of force to the parking pawl continues to occur through the existing linkage or through the selector shaft 119.

Advantageously, the previously utilized manual selector (clutch selection and parking-lock release in one) can be replaced by the pilot-operated selector or first control piston 73. Advantageously, the fewest possible solenoid and selector valves are needed, enabling both construction space and costs to be saved.

The second valve 77 alternately switches the system pressure 45 and a control pressure set by valve 89 to the first control piston 73. The first valve 71 actuates the parking lock linkage and selects the clutches 19, 21, where P represents the condition “parking lock 25 engaged,” R represents the condition “reverse clutch 21 filled and parking lock 25 disengaged,” and D represents the condition “forward clutch 19 filled and parking lock 25 disengaged.” The third valve 89 controls the control pressure of the first valve 71 when the second valve 77 has connected the control pressure.

The first valve 71 is moved to the three positions R, N, D with the help of the control pressure from the third valve 89. The reset is ensured by a spring against which the control pressure must work.

From P to R the system pressure 45 operates and pushes the first valve 71 into position R. It is reset by way of an engagement spring 125 that counteracts the first valve 71.

The fourth valve 65 is connected with the second valve 77 in such a way that it can take over the switching command for the two different working pressures, as well as the actuation of the cooling system or of the cooling oil regulating valve 67. The second valve 77 is fed by the system pressure 45 and the control pressure from valve 89, and thus can apply pressure to the first valve 71 in every driving condition. The first valve 71 operates against an externally applied parking pawl and engagement spring 125, which pushes the cylinder back into its initial position at the zero pressure position.

The interconnections of the hydraulic system 1 shown in FIG. 1 ensures the following safety functions. In the event of an electric power failure, both clutches 19, 21 are automatically switched to zero pressure. At the same time the parking lock 25 is hydraulically released (engagement position), since the pressure regulator of the first valve 71, i.e. the third valve 89, becomes depressurized, and at the same time the second valve 77 is switched to the “pilot pressure” position (the motor vehicle 5 is secured against rolling away).

As an additional safety control and regulator input, a travel/position sensing system 127, 129 is applied to the selector shaft 119 based on the existing sensors. The sensors report to the control device the position and the direction of motion of the selector shaft 119, or of the first valve 71, or of the first control piston 73, when selecting the clutch. With the help of the sensors, the regulator can move to one of the shift positions N, P, D. That makes it possible to detect an incorrect choice of the clutches 19, 21, or a hanging of the first control piston 73.

To increase the system pressure 45 during the release of the parking lock 25, it is conceivable to simultaneously operate the seventh valve 51 of the second valve arrangement 13 in any desired adjusting direction, whereby the system pressure 45 is increased, for example to up to 50 bar, through the downstream-connected OR element 63 and the system pressure valve 49.

It is possible by means of the hydraulic system 1 shown in FIGS. 1 and 2 to replace formerly necessary manual selectors for selecting the clutch and/or for actuating the parking lock 25 with the pilot-controlled first control piston 73. The overall result is a hydraulic system 1 that requires the least possible construction space and a small number of solenoids and selector valves.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A hydraulic system for controlling a belt-driven conical-pulley transmission of a motor vehicle, wherein the transmission has a variably adjustable transmission ratio, said hydraulic system comprising:
a first valve arrangement for providing pressurized hydraulic fluid for maintaining a contact pressure between pairs of conical disks and an endless torque-transmitting means of the belt-driven conical-pulley transmission;
a second valve arrangement for providing pressurized hydraulic fluid for controlling the transmission ratio of the belt-driven conical-pulley transmission; and
a hydraulic energy source to supply the hydraulic system with hydraulic energy;
wherein a third valve arrangement is included for providing pressurized hydraulic fluid to control operation of a forward clutch, operation of a reverse clutch, and operation of a parking lock.

2. A hydraulic system in accordance with claim 1, wherein the third valve arrangement includes a first valve having a control piston for mechanical actuation of the parking lock and for hydraulic actuation of the forward clutch and the reverse clutch.

3. A hydraulic system in accordance with claim 2, wherein the third valve arrangement includes a second valve positioned upstream from the first valve for selectively supplying the first valve with one of a system hydraulic pressure and a control pressure that is less than the system pressure.

4. A hydraulic system in accordance with claim 3, wherein the third valve arrangement includes a third valve positioned upstream from the first valve to actuate the control piston of the first valve.

5. A valve arrangement in accordance with claim 1, wherein the third valve arrangement includes a fourth valve positioned upstream from the second valve to actuate a control piston of the second valve.

6. A hydraulic system in accordance with claim 2, wherein the control piston of the first valve is operatively connected to actuate the parking lock mechanically by controlling a position of a lever of a selector shaft of the belt-driven conical-pulley transmission.

7. A hydraulic system in accordance with claim 6, wherein the lever and the selector shaft are operatively connected to an engagement spring to provide an engagement force for engaging the parking lock.

8. A hydraulic system in accordance with claim 3, wherein by means of the control piston of the first valve
a first selector position (P) to engage the parking lock and switch the forward and reverse clutches to zero pressure,
a second selector position (R) to apply pressure to the reverse clutch and switch the forward clutch to zero pressure,
a third selector position (N) to switch the forward clutch and the reverse clutch to zero pressure, and
a fourth selector position (D) to apply pressure to the forward clutch and switch the reverse clutch to zero pressure,
are selectively alternatively actuatable.

9. A hydraulic system in accordance with claim 8, wherein the first valve is actuated with the system hydraulic pressure to change from the first selector position (P) to the second selector position (R).

10. A hydraulic system in accordance with claim 8, wherein the first valve is actuated with the control pressure to actuate one of the second, third, and fourth selector positions (R, N, D).

11. A hydraulic system in accordance with claim 8, including a sensor for detecting the first through fourth selector positions (P, R, N, D) of the control piston of the first valve.

12. A hydraulic system in accordance with claim 2, wherein the first valve is connected upstream of the hydraulic energy source through a fifth valve.

13. A hydraulic system in accordance with claim 12, wherein the fifth valve is connected upstream of a sixth valve to actuate the fifth valve.

14. A hydraulic system in accordance with claim 1, including a fourth valve arrangement for controlling a volumetric flow of cooling oil to cool the clutches.

15. A hydraulic system in accordance with claim 14, wherein the fourth valve arrangement includes a fourth valve for actuation of a cooling oil flow regulating valve.

16. A belt-driven conical-pulley transmission having a hydraulic system in accordance with claim 1.

17. A motor vehicle having a belt-driven conical-pulley transmission in accordance with claim 16.
